(19) United States
(12) Patent Application Publication
(10) Pub. No.: US 2006/0073272 A1
(43) Pub. Date: Apr. 6, 2006

(54) Control panel and method of manufacturing

(75) Inventor: Alain Carel, Vancouver (CA)

Correspondence Address: FOLEY & LARDNER LLP, 777 EAST WISCONSIN AVENUE, SUITE 3800, MILWAUKEE, WI, 53202-5308, US

(73) Assignee: ClearPath Technologies Corp.

(21) Appl. No.: 11/236,305

(22) Filed: Sep. 27, 2005

Related U.S. Application Data
(60) Provisional application No. 60/613,683, filed on Sep. 28, 2004.

(51) Int. Cl. B05D 5/12

(52) U.S. Cl. 427/126.3

(57) ABSTRACT

A control panel and method of manufacturing a control panel that can be used with an electrically sensitive control device (e.g., a touch sensor, etc.) is disclosed. The control panel includes a substrate layer having a first surface and a second surface. A conductive coating is provided that is viewable from the first surface. The conductive coating defines at least one of a background area and a fill area. The background area is electrically isolated from the fill area. According to one embodiment, the background area and the fill area are both defined by the conductive coating.

### CROSS-REFERENCE TO RELATED PATENT APPLICATIONS

This application claims the benefit under 35 U.S.C. 119(e) of U.S. Provisional Application No. 60/613,683, having a filing date of Sep. 28, 2004, titled “CONTROL PANEL AND METHOD OF MANUFACTURING,” the disclosure of which is hereby incorporated by reference.

### FIELD

The present invention relates generally to field of control panels. More particularly, the present invention relates to the appearance of control panels as viewed by a user. The present invention further relates to control panels capable of being used with an electrically sensitive sensor configured to detect the presence of an object within a sensory region.

### BACKGROUND

Today, many home appliances, industrial equipment, and other apparatuses make use of a control panel having a user actuatable sensor to control a function of the apparatus. Such control panels are commonly used as a replacement for more conventional mechanical switches such as dials, buttons, handles, levers, and the like. Unlike conventional mechanical switches, control panels employing such sensors typically do not include any movable parts that are susceptible to wear and fatigue.

One type of control panel that is often used, is a touch panel. Touch panels include touch sensors that are actuatable when an object contacts the portion of the touch panel corresponding to the touch sensor. Such touch sensors are commonly based upon capacitive principles, and provide a signal to a control circuit based upon detected fluctuations in capacitance. When multiple touch sensors are used with a single touch panel, the touch sensors must be electrically isolated so that fluctuations detected by one touch sensor do not interfere with the operation of a second touch sensor.

A recent trend in household appliances, particularly kitchen appliances, is to provide the housing or body of the appliance with a metallic finish. The addition of a metallic finish, such as a stainless steel finish, may give the appliance a “commercial appearance” that is desired by a substantial portion of the consumer market. Such appliances may further include touch panels employing touch sensors relying on capacitive principles to control a function of the appliances. In such applications, the touch panels are generally glass panels that are mounted to the appliance. For aesthetic purposes, manufacturers typically apply a colored coating behind the touch panel. The colored coating is used to define a sensory region on the touch panel and/or a background area.

To date, manufacturers have been unable to use a color coating made of a conductive material (e.g., a metallic finish, etc.) to define a sensory region and/or a background area on the touch panel. A full coating of a conductive material applied behind the touch panel would interfere with the operation of the touch sensors. Accordingly, to date, manufacturers have been unable to provide touch panels having a metallic coating that corresponds with the finish of the apparatus that has the appearance of a visually continuous metallic finish.

Thus, there is a need for a control panel that has the appearance from a front surface of a full, uniform, and/or continuous metallic coating (e.g., visually continuous, etc.). There is further a need for a control panel that employs a conductive coating and that can be used with a control system having electrically sensitive sensors or devices. Further still, there is a need for a control panel that combines a conductive coating and a colored substance to define the key areas of the control panel. Yet further still, there is a need for a control panel that has a conductive coating capable of giving the control panel the appearance having a uniform and/or continuous metallic finish and yet includes necessary breaks in the conductive coating to enable a control system to sufficiently operate. Even further, there is a need for a method of manufacturing a control panel having a conductive coating with breaks to allow for the proper operation of a control system. It would be advantageous to provide a control panel and method of manufacturing a control panel that provides any one or more of these or other advantageous features in a variety of configurations.

### SUMMARY

According to one embodiment, a control panel includes a substrate layer having a first surface and a second surface, a conductive coating viewable from the first surface of the substrate layer, and a nonconductive coating viewable from the first surface of the substrate layer. The nonconductive coating separates a first area having the conductive coating from a second area having the conductive coating.

According to another embodiment, a control panel includes a substrate layer having a first surface and a second surface, a conductive coating viewable from the first surface, and a key area having a fill area isolated from the background area. At least one of the fill area and the background area is provided by the conductive coating.

According to another embodiment, a method of manufacturing a control panel that includes the steps of providing a substrate layer having a first surface and a second surface, adding a first coating behind the second surface of the substrate layer, and removing a portion of the first coating to form a gap between a background area and a fill area.

Another embodiment relates to a method of manufacturing a control panel for use with an electrically sensitive control device that includes the step of providing a substrate layer having a first surface and a second surface. The first surface is configured to be an exposed surface during use and the second surface is configured to be a concealed surface. The method further includes the steps of adding a conductive coating behind the second surface of the substrate layer, and removing a portion of the conductive coating to isolate a background area from a fill area.

### BRIEF DESCRIPTION OF THE DRAWINGS

FIG. 1 is a perspective view of a control panel according to an exemplary embodiment.

FIG. 2 is a detailed partial front plan view of the control panel of FIG. 1.

FIG. 3 is a front view of a control panel according to one embodiment.

FIGS. 4a and 4b are schematic views illustrating a method of manufacturing the control panel of FIG. 3 according to one embodiment.

FIGS. 5a through 5c are schematic views illustrating a method of manufacturing the control panel of FIG. 3 according to another embodiment.

FIGS. 6a through 6c are schematic views illustrating a method of manufacturing the control panel of FIG. 3 according to another embodiment.

FIGS. 7a through 7b are schematic views illustrating a method of manufacturing the control panel of FIG. 3 according to another embodiment.

FIG. 8 is a front view of a control panel according to another embodiment.

FIGS. 9a through 9c are schematic views illustrating a method of manufacturing the control panel of FIG. 8 according to another embodiment.

FIGS. 10a through 10c are schematic views illustrating a method of manufacturing the control panel of FIG. 8 according to another embodiment.

FIGS. 11a through 11c are schematic views illustrating a method of manufacturing the control panel of FIG. 8 according to another embodiment.

FIG. 12 is a front view of a control panel according to another embodiment.

### DETAILED DESCRIPTION

Before proceeding with the description of a number of exemplary embodiments of the invention in detail, it is to be understood that the invention is not limited to the details or methodology set forth in the following description or illustrated in the drawings. The invention is capable of other embodiments or being practiced or carried out in various ways. It is also to be understood that the phraseology and terminology employed herein is for purpose of description and should not be regarded as limiting.

In general, the control panel described in this disclosure can be used by manufacturers of appliances, displays, or other devices (hereinafter referred to as “apparatuses”) to provide a control panel that appears to have a uniform and/or continuous metallic finish (e.g., a visually continuous metallic finish, etc.). The control panel is capable of being used with a user interface coupled to a control system (the combination of which may be referred to herein as a “control panel system”). According to an exemplary embodiment, the control panel is capable of being used with an electrically sensitive sensor coupled to a control system. It should be noted at the outset that the control panel disclosed herein is equally applicable for control panel systems employing a mechanical user interface (knobs, switches, push-buttons, dials, etc.). The teaching herein apply to any control panel application where it is desirable to match, accent, contrast, or otherwise coordinate with the color and/or other aesthetic characteristics of the apparatus. For example, the control panel may be configured to have a stainless steel finish that matches a stainless steel apparatus to which the control panel is incorporated.

The control panel described in this disclosure is suitable for use in a variety of applications, including residential, commercial, institutional, educational, and/or industrial applications. In one application, the control panel is configured as a control panel for a kitchen appliance, such as a stove, oven, cook-top, or the like. According to various alternative embodiments, the control panel may be used with other household appliances, communication devices, computers, and/or equipment. For example, the control panel is suitable for use to control functions of apparatuses such as microwave ovens, refrigerators, and dishwashers, washing machines, dryers, or the like.

The control panel described in this disclosure is capable of being used with any control system to provide a control panel. For example, the control panel may be used with a control system having an electrically sensitive sensor (e.g., sensors based on capacitive, resistive, or other properties) and/or a mechanical interface (e.g., knobs, switches, dials, push-buttons, etc.). In the case of a kitchen oven, the control system can be configured to control such functions as turning the oven on or off, adjusting the oven temperature, setting a timer, turning an oven light on or off, activating an exhaust fan, setting a clock, or any other function commonly provided by an oven.

A control system employing an electrically sensitive sensor may include a capacitive sensing device or sensor for detecting fluctuations in capacitance. Such devices or sensors may be referred to herein as “capacitive pick-up” sensors or devices. The capacitive pick-up sensor provides a signal to a control circuit representative of differences in capacitance realized by the sensor.

According to one embodiment, the control panel is configured to be used with a control system that is a capacitive touch sensing system employing a capacitive pick-up sensor that is supported behind a control panel. The capacitive pick-up sensor is a touch sensitive element that is operably coupled to a controller or a control circuit. The controller analyzes signals associated with the touch sensitive element to identify a touch. The touch sensor can be actuated by touching the control panel. The control panel may be touched with a variety of objects such as by a fingertip, a utensil, or other body part.

An example of a touch sensor suitable for use with the control panel disclosed herein is provided in U.S. patent application entitled “CAPACITIVE TOUCH SENSOR USING ENCODED EXCITATION SIGNALS” filed Jul. 23, 2004 and claiming priority to U.S. Provisional Application 60/533,538, which is hereby incorporated by reference in its entirety. However, it should be again noted that the various embodiments of the control panel, and the various embodiments of manufacturing a control panel, provided herein, are suitable for use with any generally known or otherwise suitable capacitive sensing device or sensor, and is further applicable with other electrically sensitive sensors or devices, and/or mechanical interfaces.

In a typical application employing capacitive pick-up sensors, a control panel system allows a user to send a plurality of commands to control an apparatus. To provide such a configuration, more than one capacitive pick-up sensor is employed, such as an array of capacitive pick-up sensors. When more than one capacitive pick-up sensor is being used with a common control panel, the capacitive pick-up sensors must be separated in manner sufficient to prevent the differences in capacitance being realized by a first capacitive pick-up sensor controlling a first function from being realized by a second capacitive pick-up sensor controlling a second function (e.g., electrically separated, etc.).

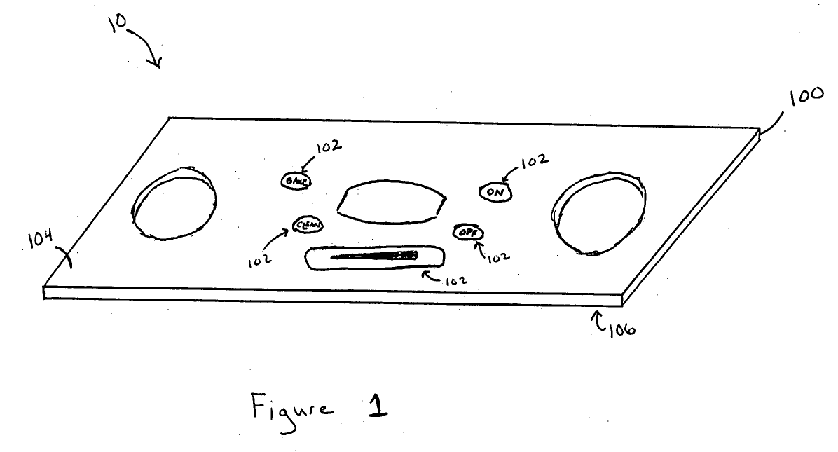

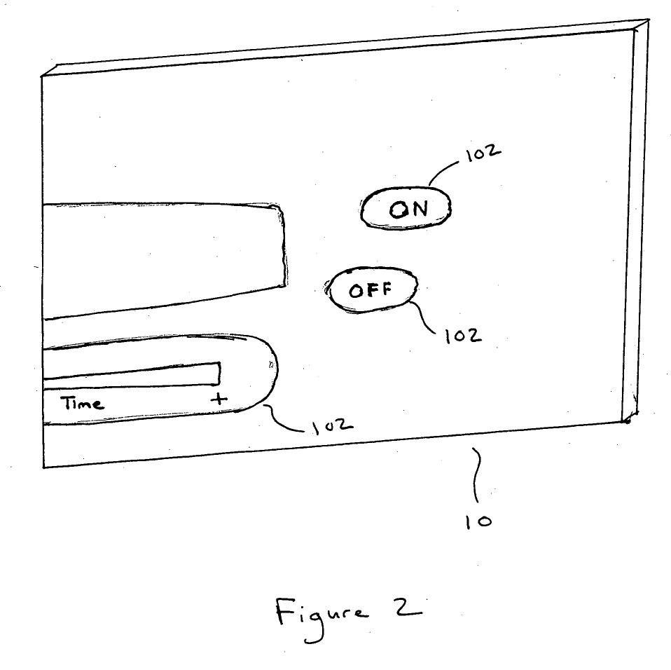

FIGS. 1 and 2 illustrate a control panel 10 that is suitable for use with a control system to provide a control panel. It should be understood that FIGS. 1 and 2 merely illustrate one embodiment, and control panel 10 may include a variety of configurations. Control panel 10 generally includes a plate member or substrate (e.g., display panel, touch panel, control plate, etc.), shown as panel 100, having at least one sensory region (e.g., actuation area, sensory zone, touch zone, key pad, etc.), shown as a key area 102. According to an exemplary embodiment, the key area 102 corresponds to the location of a capacitive pick-up sensor of a control system. The combination of control panel 10 and a control system may be used as a replacement for more conventional mechanical interfaces.

Panel 100 has a first or front surface 104 and a second or back surface 106. Front surface 104 is preferably an outer surface that is viewable (visible) by a user. According to the particular embodiment illustrated, front surface 104 is an exposed surface that is accessible to the user. For example, front surface 104 may be the touch surface of a touch panel system. In another embodiment, an intermediate member may be positioned in front of front surface 104. Back surface 106 is preferably an inner surface that is viewable by a user by a user looking through front surface 104.

In one embodiment, panel 100 is configured as a separate control panel for an apparatus (e.g., a control panel for an oven). For example, panel 100 may be a generally rectangular member coupled to a portion of the apparatus. As can be appreciated, panel 100 may be provided in a variety of shapes having linear or curved edges, or any combination thereof. In another embodiment, panel 100 is an area of a larger panel. For example, panel 100 may be configured as an area of a glass ceramic plate of a cook-top. In such a configuration, a panel 100 may be integrally formed with the larger panel.

Panel 100 is preferably made of glass, but alternatively can be made of any other conventionally known or otherwise appropriate dielectric material (e.g., plastic, epoxy, etc.). Panel 100 may be a relatively rigid member, or alternatively may be a relatively flexible member. According to the particular embodiment illustrated, control panel 100 is made of a relatively rigid glass panel that is suitable for use as a touch panel.

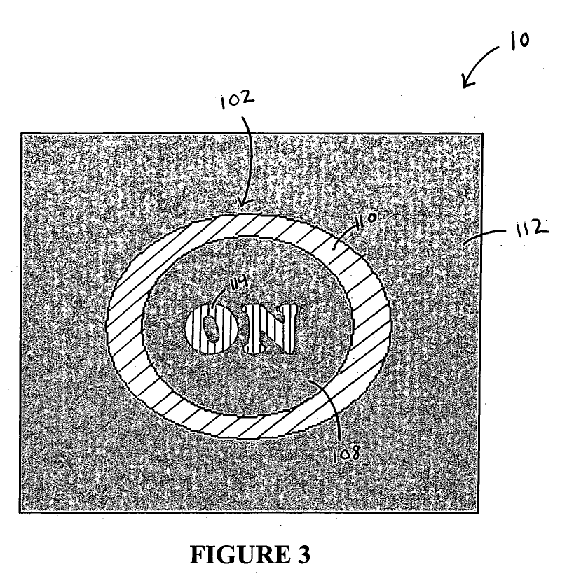

Referring to FIGS. 3, 8, and 12, key area 102 of panel 100 represents an area on the panel wherein a user can actuate a control system by selectively sending a command to control a function of the apparatus. Key area 102 is generally defined by a fill area 108 and a boarder region 110. In one embodiment, capacitive pick-up sensor is configured to be supported adjacent to fill area 108. Boarder region 110 visually separates fill area 108 from a background area 112 (e.g., surrounding region, etc.) so that a user can distinguish the key area from the background area. Boarder region 110 may be a relatively thin boundary that separates background 112 from fill area 108, or alternatively may be a relatively wide or otherwise pronounced boundary.

According to the particular embodiment illustrated, boarder region 110 is a circular ring extending continuously around fill area 108. As can be appreciated, boarder region 110 may have any of a variety of shapes such as shapes having linear and/or curved lines. In addition, the width of boarder region 110 can vary and does not have to be uniform.

Fill area 108 may optionally include a marking (e.g., indicia, nomenclature, text, number, symbol, word, etc) shown as marking 114. Marking 114 may be used to inform the user of the corresponding command that will be sent to the control system if an object is sensed in the key area. According to the particular embodiments illustrated, marking 114 is in the form of the word “ON,” and may in alternative embodiments includes words such as “OFF,” “BAKE,” “TEMP,” “TIME,” “CLEAN,” etc. In various alternative embodiments, marking 114 may further be in the form of numbers, symbols, and the like. For example, key areas 102 may be arranged as a QWERTY keyboard or a numeric keypad, and markings 114 may be in the form of the corresponding letters or numbers respectively.

Fill area 108, boarder region 110, background 112, and marking 114 are preferably defined by a coating (i.e., substance, etc.) or a plurality of coatings supported behind back surface 106 of panel 100. According to the particular embodiment illustrated, a first coating or substance 116 is provided to define fill area 108, a second coating or substance 118 is provided to define boarder region 110, a third coating or substance 120 is provided to define background 112, and a fourth coating or substance 122 is provided to define marking 114. The combination of first coating 116 and third coating 120 may be referred to as a coating 40. The coatings are preferably coupled to back surface 106 of panel 100, but alternatively may be coupled to an intermediate layer.

For purposes of this disclosure, the term “coupled” means the joining of two members (e.g., materials, coatings, joining of a coating to a panel, etc.) directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

The coatings 116, 118, 120, and 122 may be made of any of a variety of materials. Coatings 116, 118, 120, and 122 can all be made of a non-conductive material, such as a colored ink capable of being affixed to panel 100. In one embodiment, coatings 116 and 120 are made of a conductive material, and preferably of a conductive coating having a metallic finish. In another embodiment, coating 122 may also be made of a conductive material. As can be appreciated, the coatings can be provided in a variety of combinations of non-conductive and conductive coatings depending upon the desired configuration.

As can be appreciated, in order for a user to sufficiently view coatings 116, 118, 120, and 122 from front surface 104 of panel 100, panel 100 is a relatively clear member having transparent and/or translucent properties. It should be noted that panel 100 may have any of a variety of aesthetic features including, but not limited to, a panel having a textured or patterned surface (e.g., raised portions, ripples, embossments, unevenness, etc.), a panel that is slightly colored (e.g., tinted, etc.), a panel having a distorted appearance (e.g., cloudy, smokey, rippled, cracked, etc.), or any other aesthetic and/or decorative feature.

As mentioned above, in a typical application, control panel 10 allows a user to send multiple commands to a control system. To provide for such a configuration, panel 100 includes a plurality of key areas 102, with each key area 102 configured to correspond to a separate capacitive pick-up device. Each key area 102 represents a different command that can be sent by a capacitive pick-up device. FIGS. 3, 8, and 12, illustrate panel 100 with only one key area 102 in order to simplify the drawings. As can be appreciated, control panel 100 is likely to include a plurality of key areas 102 arranged in a variety of configurations (e.g., columns, rows, clusters, etc.).

According to the embodiment illustrated in FIG. 3, the coatings 120, 108, which are employed to define background area 112 and fill area 108 respectively, are comprised of a conductive material. According to a preferred embodiment, the conductive material is capable of giving panel 100 the appearance of a metallic finish when viewed from front surface 104. Background 112 and fill area 108 may have the appearance of being the same metallic finish, or alternatively, may have different finishes. According to a particularly preferred embodiment, the conductive material provides a stainless steel metallic finish for panel 100. In alternative embodiments, the conductive material may provide other metallic finishes including, but not limited to, chrome, brushed nickel, bronze, brass, pewter, copper, etc.

To provide a control panel 10 having multiple key areas 102 corresponding to multiple capacitive pick-up sensors, fill areas 108 are isolated (e.g., independent, electrically separated, etc.) from background area 112. In one embodiment, a non-conductive gap is provided between fill areas 108 and background 112. The non-conductive gap represents a break in the conductive material. Boarder region 110 may advantageously be used to hide or otherwise conceal the area of isolation (i.e., break area, gap, boundary, etc.) so that panel 100, from front surface 104, has the appearance of having a continuous or uniform metallic finish.

According to an exemplary embodiment, boarder region 110 provides a colored separation between fill area 108 and background 112 that can fill the non-conductive gap. According to one embodiment, boarder region 110 and marking 114 are the same color. In an exemplary embodiment, boarder region 110 and marking 114 may be black in color. In various alternative embodiments, boarder region 110 and marking 114 may be provided in any of a variety of colors and may configured as being the same color or different colors.

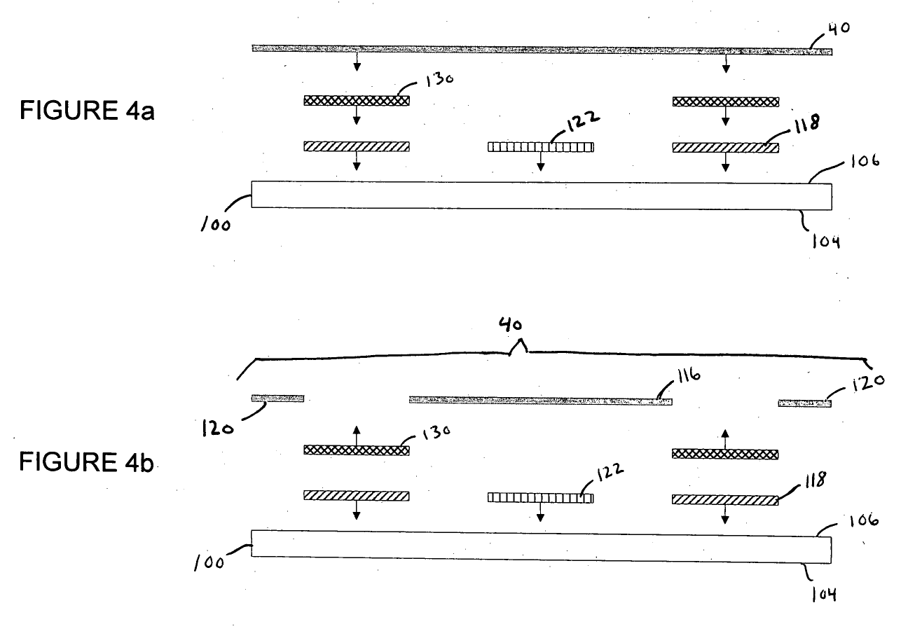

Referring to FIGS. 4a through 4c, a method of manufacturing control panel 10, as shown in FIG. 3, is illustrated according to an embodiment. Referring particularly to FIG. 4a, the method includes the step of forming boarder region 110 and marking 114 on back surface 106 of panel 100. According to a preferred embodiment, panel 100 is made of a relatively rigid and transparent glass panel that is suitable for use as a touch panel. Boarder region 110 and marking 114 are preferably formed of coatings 118, 122 respectively, such a graphic ink or other colored substance, that is capable of being affixed to panel 100. To provide, a non-conductive gap between fill area 108 and background 112, the colored substance is a non-conductive substance. According to an exemplary embodiment, the colored substance is high temperature frit graphic ink of a type commercially available as “Ferro Corp 175” medium for glass. According to alternative embodiments, the colored substance may be any ink, stain, dye, paint, etc. capable of being coupled to the substrate layer. According to further alternative embodiments, boarder region 110 and marking 114 may be formed utilizing an ink jet, syringe dispenser, or any other suitable technique.

According to an exemplary embodiment, boarder region 110 and marking 114 are applied to back surface 106 of panel 100 with a spraying process or operation. In one embodiment, a pattern (not shown) having missing portions corresponding to the desired boarder region 110 and marking 114 may be disposed over the back surface 106 of panel 100. A fluid, such as an ink, may then be sprayed over the pattern to obtain the desired border region 110 and marking 114. In the various alternative embodiments, boarder region 110 and marking 114 may be applied by other printing processes or techniques such as silk-screening, or any other conventional or otherwise suitable means of applying a color to a panel. As can be appreciated, different colors or substances may be used to create boarder region 110 and marking 114, or alternatively, boarder region 110 and marking 114 may be formed of the same color and/or material.

The method further includes the step of applying a second material, shown as resist material 130, over the boarder region 110 (i.e., coating 118). Resist material 130 creates a sacrificial mask or pattern that covers only boarder region 110. As explained below, this sacrificial pattern will later be removed without removing the coating 118 used to form boarder region 110. According to an exemplary embodiment, resist material 130 may applied to panel 100 by printing or photo imaging the resist material onto the panel. According to an exemplary embodiment, resist material 130 may be an ink of a type commercially available as “Part No. E6155” as provided by Ercon. According to an alternative embodiment, using a photo emulsion, the photo emulsion may be an etch resist of a type commercially available as “Riston” as provided by Dupont. Resist material 130 may be applied in a variety of other ways and may take the form of any suitable material.

Referring further to FIG. 4a, the method further includes the step of applying coating 40 to back surface 106 of panel 100. In such an embodiment, coating 40 provides for coatings 116 and 120. As mentioned above, coating 40 is preferably a conductive coating capable of providing a metallic finish. According to a particularly preferred embodiment, a stainless steal coating is applied. As illustrated in FIG. 1, coating 40 is used for both background 112 and fill area 108. According to an exemplary embodiment, coating 40 may be applied to back surface 106 with a metal deposition process, such as, vacuum deposition, vapor deposition, or any other suitable deposition process. Techniques for applying a metallic coating are generally known, and accordingly, any such technique may be used.

Referring particularly to FIG. 4b, the method further includes the step of removing the sacrificial pattern created with resist material 130. Removal of the sacrificial pattern will remove the conductive coating 40 that has been deposited on top of resist material 130. Removal of the sacrificial pattern is not intended to remove the conductive coating 40 applied to other areas of panel 100, such as background 112 and fill area 108. Removal of the conductive coating 40 provides a non-conductive gap (i.e., electrically disconnected) between fill area 108 and background 112. Accordingly, a capacitive pick-up sensor disposed behind fill area 108 will be isolated from any surrounding capacitive pick-up devices. According to an exemplary embodiment, the sacrificial pattern is removed with a chemical bath. In alternative embodiments, the sacrificial pattern may be removed by other techniques such as those involving heat, burning the resist material 130 off, or any other appropriate technique.

The method may further include the step of cleaning panel 100 to remove any residue from resist material 130. According to an exemplary embodiment, panel 1100 may be passed through a wash or other suitable means for cleansing panel 100. As can be appreciated, the colored substances used for boarder region 110 and marking 114 are preferably adapted to withstand (e.g., avoid discoloring, crazing, etc.) the application of resist material 130, the deposition of coating 40, and the subsequent removal of resist material 130.

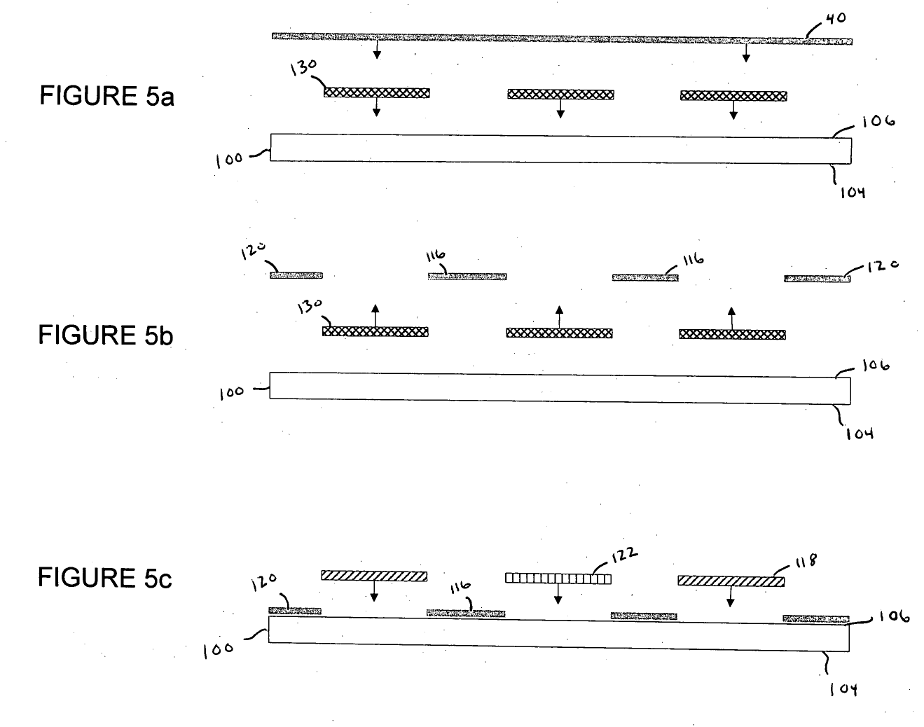

Referring to FIGS. 5a and 5c, a method of manufacturing control panel 10, as shown in FIG. 3, is illustrated according to another embodiment. Referring to particularly to FIG. 5a, the method includes the step of applying resist material 130 directly to back surface 106 of panel 100. Resist material 130 is applied to back surface 106 in the form of boarder region 110 and marking 114. As stated above, a pattern (not shown) may be used to form the desired configuration of boarder region 110 and marking 114, or alternatively other suitable techniques may be used. The method further includes the step of depositing coating 40 over back surface 106 so that resist material 130 is covered. Referring particularly to FIG. 5b, the resist material 130 may then be removed as provided above to create a non-conductive gap between filler area 108 and background 112, and to remove coating 40 from marking 114. The method may include the step of cleaning panel 100 to remove any undesirable residue. Referring particularly to FIG. 5c, the method further includes the step of applying a colored substance to the areas formally occupied by resist material 130 so that a colored boarder region 110 and marking 114 are provided. Boarder region 110 (i.e., coating 118) and marking 114 (i.e., coating 122) may have the same color, or alternatively may be of different colors.

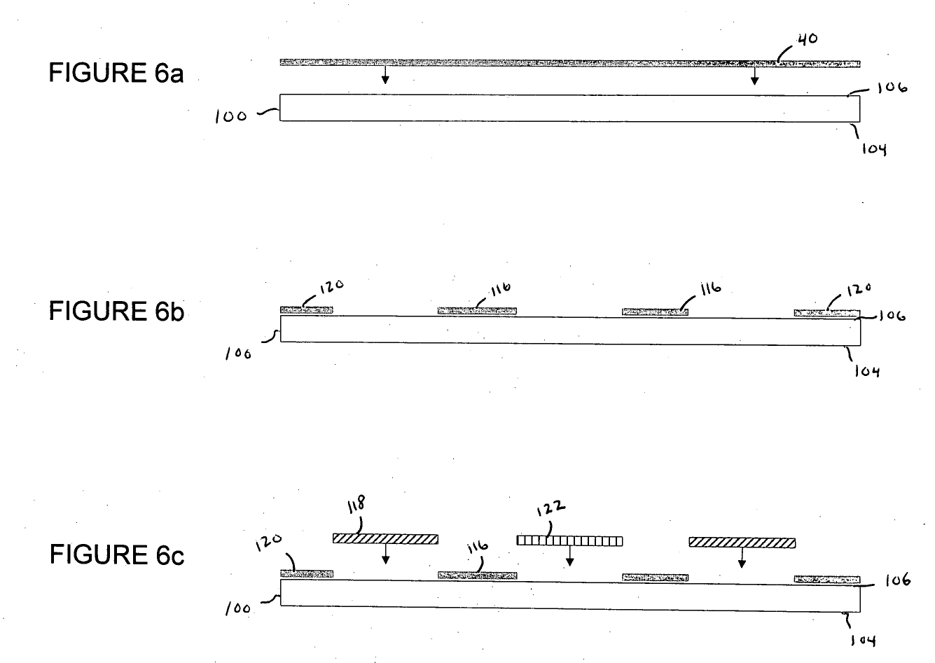

Referring to FIGS. 6a through 6c, a method of manufacturing control panel 10, as shown in FIG. 3, is illustrated according to another embodiment. Referring particularly to FIG. 6a, the method includes the step of depositing coating 40 over back surface 106 of panel 100. With reference to FIG. 6b, the method further includes the step of ablating a portion of coating 40 in a manner that forms boarder region 110 and marking 114. According to an exemplary embodiment, coating 40 may be removed using a laser or another heat source. Alternatively, coating 40 may be removed using a printed acid ink commercially available as Triangle 3007, or any other suitable technique. Once the areas for boarder region 110 and marking 114 have been removed from coating 40, panel 100 may be cleaned to further remove any undesirable residue. Referring particularly to FIG. 6c, the method further includes the step of applying coatings 118 and 122 to the areas wherein coating 40 had been removed so that a colored boarder region 110 and marking 114 are provided respectively. Boarder region 110 and marking 114 may have the same color, or alternatively may be of different colors.

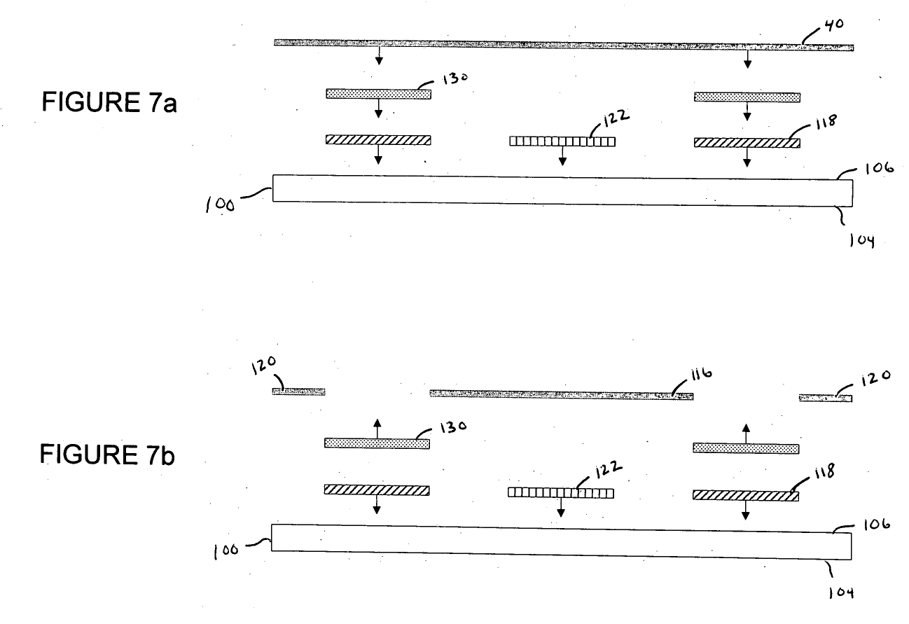

Referring to FIGS. 7a through 7b, a method of manufacturing control panel 10, as shown in FIG. 3, is illustrated according to another embodiment. Referring particularly to FIG. 7a, the method includes the step of forming boarder region 110 and marking 114 on back surface 106 of panel 100 with coating 118 and 122. The method further includes the step of applying a resist material 130 directly on top of coating 118 used to define boarder region 110. The resist material 130 is capable of providing a buffer between a laser and coating 118. The method further includes the step of depositing coating 40 over back surface 106 of panel 100, wherein coating 40 covers coatings 118, 122 used to form boarder region 110 and marking 114, and resist material 130. With reference to FIG. 7b, the method further includes the step of ablating the portion of coating 40 disposed over resist material 130 using a laser to provide a non-conductive gap between fill area 108 and background 112. Resist material 130 intended to dissipate the laser energy and thereby protect the integrity of coating 118 that defines boarder region 110.

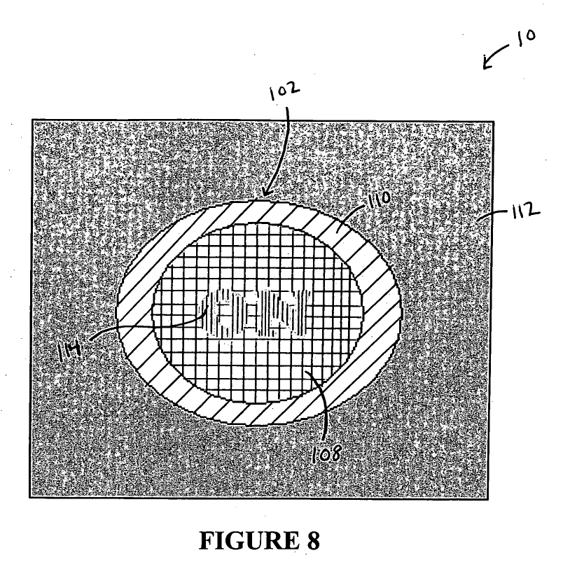

With reference to FIG. 8, another embodiment of control panel 10 is shown, and includes a key area 30 that is separated from a background 112 by a boarder region 110. The boarder region 110 may be a relatively thin boundary that separates background 112 from a fill area 108. Included within fill area 108 is a marking (e.g., indicia, nomenclature, text, number, symbol, stamp, etc) shown as marking 114.

According to an exemplary embodiment, coating 40 covers background 112. According to a preferred embodiment, coating 40 is a conductive coating capable of providing a metallic finish. Boarder region 110, fill area 108, and marking 114 are each formed with coatings 118, 121, and 122 respectively. In a preferred embodiment, boarder region 110 is provided as a first color, fill area 108 is provided as a second color, and marking 114 is provided as a third color. In various exemplary embodiments, boarder region 110, fill area 108, and marking 114 may be provided in any of a variety of colors and/or in any combination of repeated colors. According to an alternative embodiment, marking 114 may be formed with same coating 40 as background 112.

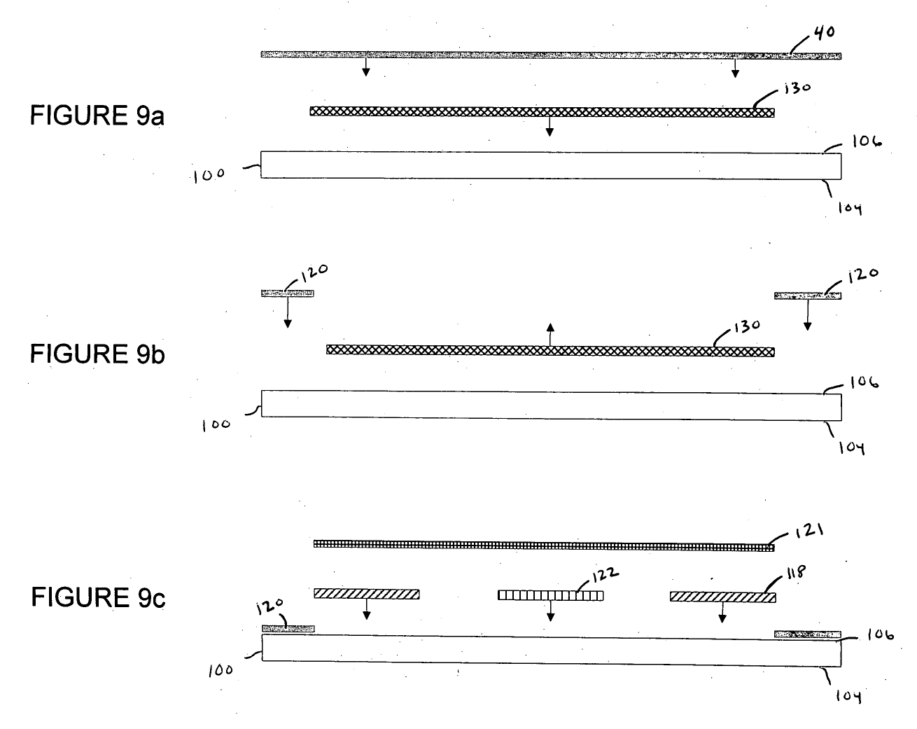

Referring to FIGS. 9a through 9c, a method of manufacturing control panel 10, as shown in FIG. 8, is illustrated according to an exemplary embodiment. Referring particularly to FIG. 9a, the method includes the step of applying a resist material 130 directly to back surface 106 of panel 100. Resist material 130 is applied to back surface 106 in the area wherein boarder region 110, fill area 108, and marking 114 are to be provided. The method further includes the step of depositing a coating 40 over back surface 106 so that resist material 130 is covered. With reference to FIG. 9b, the resist material 130 may then be removed as provided above to create an area wherein boarder region 110, fill area 108, and marking 114 are to be provided. The method may include the step of cleaning panel 100 to remove any undesirable residue. Referring particularly to FIG. 9c, the method further includes the steps of applying a first colored substance (i.e., coating 118) to create boarder region 110, applying a second colored substance (i.e., coating 122) to create marking 114, and applying a third color substance (i.e., coating 121) to create fill area 108. According to an exemplary embodiment, boarder region 110, fill area 108, and marking 114 may have the same color, or alternatively may be of different colors, or any combination thereof.

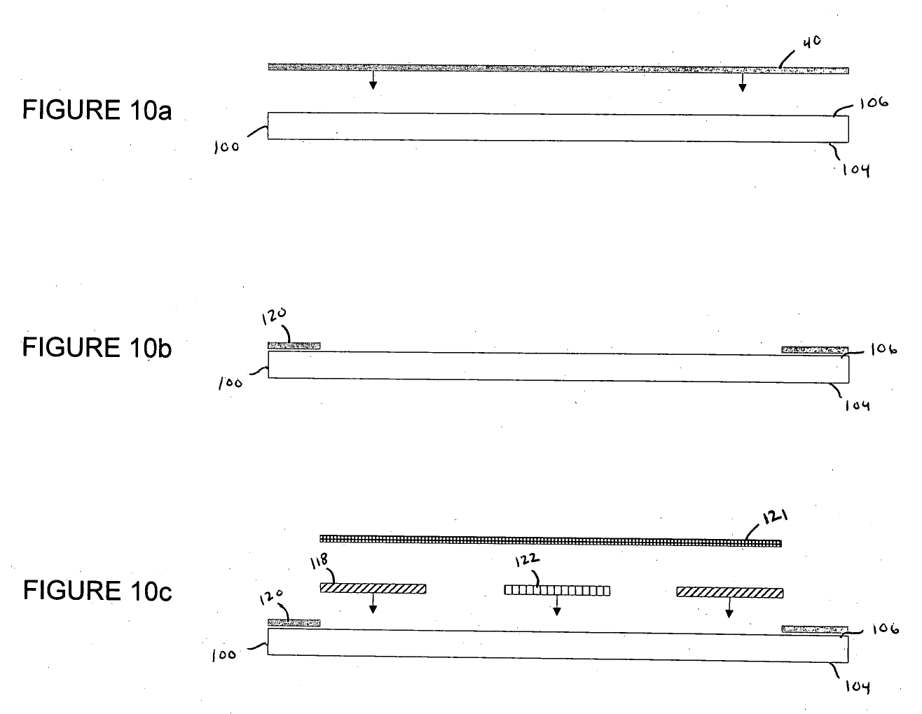

Referring to FIGS. 10a through 10c, a method of manufacturing control panel 10, as shown in FIG. 8, is illustrated according to another exemplary embodiment. Referring particularly to FIG. 10a, the method includes the step of depositing coating 40 over back surface 106 of panel 100. As shown in FIG. 10b, the method further includes the step of ablating a portion of coating 40 to remove the areas wherein boarder region 110, fill area 108, and marking 114 are to be provided. According to an exemplary embodiment, coating 40 may be removed using a laser or another heat source. Alternatively, coating 40 may be removed using a printed acid ink commercially available as Triangle 3007, or any other suitable technique. Once the desired portions of coating 40 have been removed, panel 100 may be cleaned to further remove any undesirable residue. With reference to FIG. 10c, the method further includes the steps of applying a first colored substance (i.e., coating 118) to create boarder region 110, applying a second colored substance (i.e., coating 122) to create marking 114, and applying a third color substance (i.e., coating 121) to create fill area 108. According to an exemplary embodiment, boarder region 110, fill area 108, and marking 114 may have the same color, or alternatively may be of different colors, or any combination thereof.

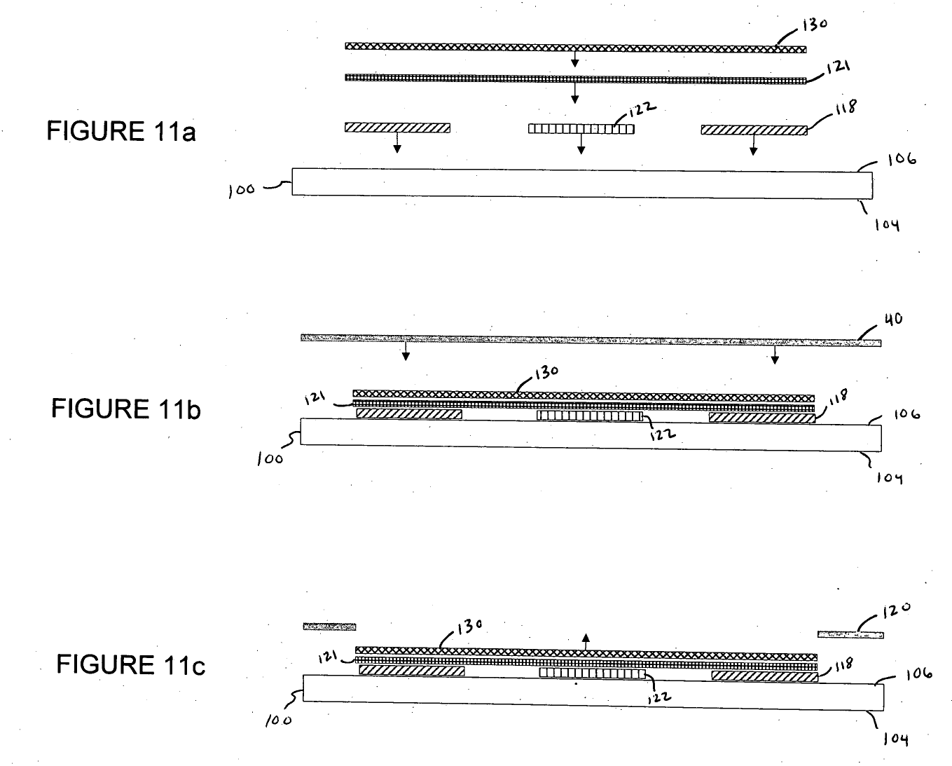

Referring to FIGS. 11a through 11c, a method of manufacturing control panel 10, as shown in FIG. 8, is illustrated according to another exemplary embodiment. Referring particularly to FIG. 11a, the method includes the steps of steps of applying a first colored substance (i.e., coating 118) to create boarder region 110, applying a second colored substance (i.e., coating 122) to create marking 114, and applying a third color substance (i.e., coating 121) to create fill area 108. According to an exemplary embodiment, boarder region 110, fill area 108, and marking 114 may have the same color, or alternatively may be of different colors, or any combination thereof. The method further includes the step of applying a second material, shown as resist material 130, over boarder region 110, fill area 108, and marking 114. Resist material 130 creates a sacrificial mask or pattern over the area for which it is applied. With reference to FIG. 11b, the method further includes the step of depositing coating 40 over back surface 106 of panel 100 thereby covering boarder region 110, fill area 108, marking 114, and resist material 130. Referring particularly to FIG. 11c, the resist material 130 may then be removed as provided above to create an area separated from the conductive coating 40. The method may include the step of cleaning panel 100 to remove any undesirable residue.

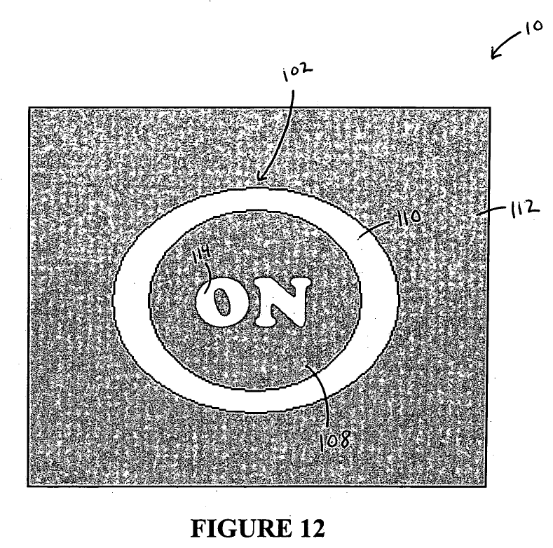

With reference to FIG. 12, another embodiment of control panel 10 is shown. Similar to the embodiment illustrated in FIG. 3, the control panel 10 shown in FIG. 12 includes a key area 30 that is separated from a background 112 by a boarder region 110. The boarder region 110 is a relatively thin boundary and provides for a fill area 108 within boarder region 110. Included within fill area 108 is a marking (e.g., indicia, nomenclature, text, number, symbol, stamp, etc) shown as marking 114.

According to an exemplary embodiment, background 112 and fill area 108 have the appearance of a metallic finish. Unlike the embodiment illustrated in FIG. 3, boarder region 110 and marking 114 are not colored, but are instead are defined by backlighting. According to an exemplary embodiment, a display device such as a liquid crystal display (LED), or a multi-colored (LED) provides the backlighting that defines boarder region 110 and marking 114. In the various embodiments, backlighting may be provided by any conventionally known or appropriate display device, such as, light emitting diodes (LEDs), multi-colored LEDs, florescent or incandescent bulbs, etc. In alternative embodiments, one of the boarder region 110 and the marking 114 may be defined by backlighting, while the other has the appearance of a colored finish.

A method of manufacturing control panel 10, as shown in FIG. 12 includes the step of applying resist material 130 directly to back surface 106 of panel 100. Resist material 130 is applied to back surface 106 in the form of boarder region 110 and marking 114. As stated above, a pattern may be used to form the desired configuration of boarder region 110 and marking 114, or alternatively other suitable techniques may be used. The method further includes the step of depositing coating 40 over back surface 106 so that resist material 130 is covered. The resist material 130 may then be removed as provided above to create a non-conductive gap between filler area 36 and background 112, and to remove coating 40 from marking 114. The method may include the step of cleaning panel 100 to remove any undesirable residue. For such an embodiment, boarder region 110 and marking 114 may be left clear so that backlighting may be used to define the areas rather than a colored substance.

A method of manufacturing control panel 10, as shown in FIG. 12, according to another embodiment, includes the step of depositing coating 40 over back surface 106 of panel 100. The method further includes the step of ablating a portion of coating 40 in a manner that forms boarder region 110 and marking 114. According to an exemplary embodiment, coating 40 may be removed using a laser or another heat source. Alternatively, coating 40 may be removed using a printed acid ink commercially available as Triangle 3007, or any other suitable technique. Once the areas for boarder region 110 and marking 114 have been removed from coating 40, panel 100 may be cleaned to further remove any undesirable residue. For such an embodiment, boarder region 110 and marking 114 may be left clear so that backlighting may be used to define the areas rather than a colored substance.

It is important to note that the construction and arrangement of the elements of the control panel as shown in the preferred and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited.

For example, while the few embodiments of the present inventions that have been described in detail in this disclosure each describe applying background 112, boarder region 10, fill area 108, and marking 114 to the back surface of panel 100, it should be understood that in various alternative embodiments, background 112, boarder region 110, fill area 108, and/or marking 114 may be provided on an additional member. For such a configuration, the additional member may be positioned behind back surface 106 of panel 100 and still be viewable from front surface 104. In such an embodiment, background 112, boarder region 110, fill area 108, and/or marking 114 may be applied on a front surface of a relatively opaque member, or to a front or back surface of a relatively transparent member. It is possible for at least one of background 112, boarder region 110, fill area 108, and/or marking 114 to be provided on panel 100 and another of background 112, boarder region 110, fill area 108, and/or marking 114 to be provided on the additional member position behind panel 100. Background 112, boarder region 110, fill area 108, and/or marking 114 may be applied to an additional member using methods similar to those described in detail.

Further, elements shown as integrally formed may be constructed of multiple parts or elements shown as multiple parts may be integrally formed, the operation of the interfaces may be reversed or otherwise varied, or the length or width of the structures and/or members or connectors or other elements of the system may be varied. It should be noted that the elements and/or assemblies of the system may be constructed from any of a wide variety of materials that provide sufficient strength or durability, in any of a wide variety of colors, textures and combinations. It should also be noted that the step members may be configured in a suitable cross sectional shape (e.g. rectangular, triangular, oval, etc.).

Accordingly, all such modifications are intended to be included within the scope of the present inventions. Other substitutions, modifications, changes and omissions may be made in the design, operating conditions and arrangement of the preferred and other exemplary embodiments without departing from the spirit of the present inventions.

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the inventions as expressed in the appended claims.

What is claimed is:

1. A control panel comprising:
a substrate layer having a first surface and a second surface;
a key area on the substrate layer and having a fill area electrically isolated from a background area; and
a conductive coating provided behind the second surface and viewable from the first surface,
wherein the conductive coating defines at least one of the fill area and the background area.

2. The control panel of claim 1, wherein the substrate layer is a relatively rigid member.

3. The control panel of claim 1, wherein the conductive coating is coupled to the second surface of the substrate layer.

4. The control panel of claim 3, wherein the conductive coating is directly coupled to the second surface.

5. The control panel of claim 1, wherein the key area corresponds to an intended location of an electrically sensitive control device.

6. The control panel of claim 1, further comprising a plurality of key areas each having fill areas electrically isolated from the other plurality of key areas.

7. The control panel of claim 1, wherein a boarder region electrically isolates the fill area from the background area.

8. The control panel of claim 1, further comprising a marking provided in the fill area, wherein the marking includes nomenclature corresponding to a function of the control panel.

9. The control panel of claim 1, wherein the conductive coating defines the fill area and the background.

10. The control panel of claim 1, wherein the conductive coating provides a metallic finish.

11. A control panel comprising:
a substrate layer having a first surface and a second surface;
a plurality of key areas on the substrate layer corresponding to intended locations of electrically sensitive control devices; and
a conductive coating provided behind the second surface and viewable from the first surface,
wherein the conductive coating defines the key areas and a background area surrounding the key areas.

12. The control panel of claim 11, wherein a gap electrically isolates the key areas from the background area.

13. The control panel of claim 12, wherein a nonconductive coating fills the gap between the key area and the background area.

14. A method of manufacturing a control panel for use with an electrically sensitive control device, the method comprising:
providing a substrate layer having a first surface and a second surface;
adding a first coating behind the second surface of the substrate layer; and
removing a portion of the first coating to form a gap between a background area and a fill area,
wherein the fill area corresponds to an intended location for a electrically sensitive sensor.

15. The method of claim 14, wherein the first coating is a conductive coating.

16. The method of claim 15, wherein the first coating provides a metallic finish.

17. The method of claim 14, wherein the first coating defines the background area.

18. The method of claim 17, further comprises the step of adding a second coating behind the second surface of the substrate layer.

19. The method of claim 18, wherein the second coating is a nonconductive coating defining the fill area.

20. The method of claim 18, wherein the second coating is a conductive coating defining the fill area.
